(19) United States
(12) Patent Application Publication
(10) Pub. No.: US 2010/0045560 A1
(43) Pub. Date: Feb. 25, 2010

(54) ANTENNA

(75) Inventors: Masao SAKUMA, Yokohama (JP); Yoshikazu OKA, Yokohama (JP)

Correspondence Address: ARENT FOX LLP, 1050 CONNECTICUT AVENUE, N.W., SUITE 400, WASHINGTON, DC, 20036, US

(73) Assignee: FUJITSU MICROELECTRONICS LIMITED, Tokyo (JP)

(21) Appl. No.: 12/512,755

(22) Filed: Jul. 30, 2009

Related U.S. Application Data
(63) Continuation of application No. PCT/JP2007/051677, filed on Feb. 1, 2007.

(51) Int. Cl. H01Q 9/16; H01Q 1/38

(52) U.S. Cl. 343/793; 343/700 MS; 343/795

(57) ABSTRACT

An antenna includes a substrate made of a dielectric material, a first different dielectric constant region having a dielectric constant different from a dielectric constant of said substrate provided in said substrate, and a first antenna element provided on a front surface of said substrate.

### CROSS-REFERENCE TO RELATED APPLICATIONS

This application is a Continuation of International Application No. PCT/JP2007/051677, with an international filing date of Feb. 1, 2007, which designating the United States of America, the entire contents of which are incorporated herein by reference.

### FIELD

The embodiment invention relates to an antenna.

### BACKGROUND

Recently, with expansion of demands of communication, small-sized radio devices such as cellular phone and so on are widely used. Many small-sized devices contain antennas in their casings. The internal antenna is required to be suitable for downsizing and light-weighting and have low cost and wide performance. Further, in daily life greatly, the influence when people directly touch the radio device or the influence by a conductor near the radio device affects the radiation characteristics of the internal antenna, so that its performance varies. Therefore, an antenna having a small change in characteristics due to the external influence is increasingly required.

In the conventional major kinds of antenna, the antenna could not be downsized because the antenna gain was not secured when the size of the antenna was reduced. Further, because of the narrow bandwidth of the resonant frequency of the antennas themselves, there was a phenomenon that the resonant frequency changes due to external influence, whereby the voltage standing wave ratio deteriorates to increase the consumption of battery, resulting in waste of the battery. Further, the antenna design was very difficult because the radiation pattern is affected by the influence of the casing in which the small-sized radio device is installed.

In addition, an antenna is required which is easily reduced in size and secure a state in which when the antenna is attached to the casing or the like of the radio device, the antenna radiation characteristics never change due to the casing to which the antenna is attached. Further, it is a challenge to realize an antenna which never causes change in the resonant frequency and change in the voltage standing wave ratio due to the influence of a human body or the influence of a conductor placed near the antenna.

Japanese Laid-open Patent Publication No. 2001-168637 discusses a print-type dipole antenna which has a small occupied space and is therefore suitable for downsizing. Japanese Laid-open Patent Publication No. 2003-209429 discusses an antenna device which is used for base station antenna device in mobile communication and attainable of two resonant characteristics as well as small in size and simple in structure and easy to manufacture. Japanese Laid-open Patent Publication No. 2000-278025 discusses a dipole antenna device which shares a plurality of frequency bands and is made to have a wider band for a first frequency band among them.

### SUMMARY

According to an aspect of the embodiment, An antenna includes a substrate made of a dielectric material, a first different dielectric constant region having a dielectric constant different from a dielectric constant of said substrate provided in said substrate, and a first antenna element provided on a front surface of said substrate.

### BRIEF DESCRIPTION OF THE DRAWINGS

FIG. 1 is a view illustrating a front surface and a rear surface of a substrate seen through the substrate;

FIG. 2 is a view illustrating the front surface of the substrate;

FIG. 3 is a view illustrating the rear surface of the substrate;

FIG. 4 is a view for explaining details of antenna elements;

FIG. 5 is a perspective view illustrating a first antenna element on the front surface of the substrate and a second antenna element on the rear surface;

FIG. 6 is a sectional view of a region where the first antenna element and the second antenna element mutually overlap Microstip line;

FIG. 7 is a graph depicting measurement results of the antenna according to the present embodiment VSWR; and

FIG. 8 is a Smith chart depicting measurement results of the antenna according to the present embodiment.

### DESCRIPTION OF THE EMBODIMENTS

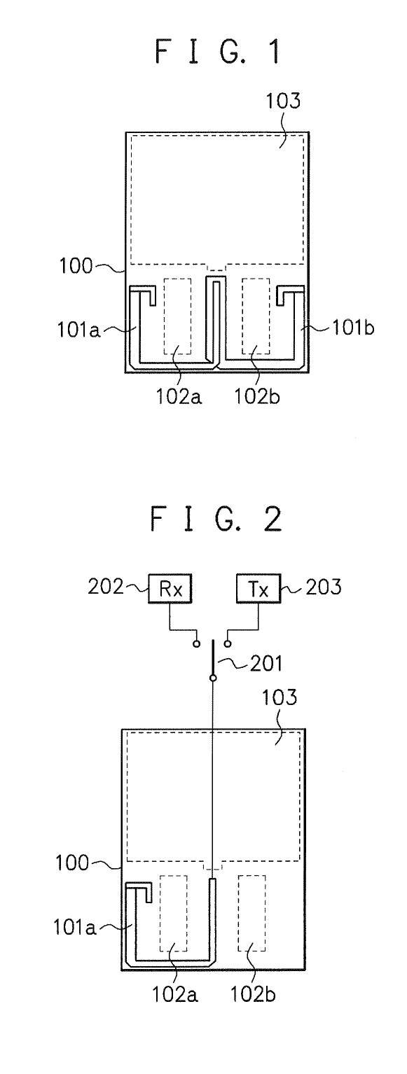

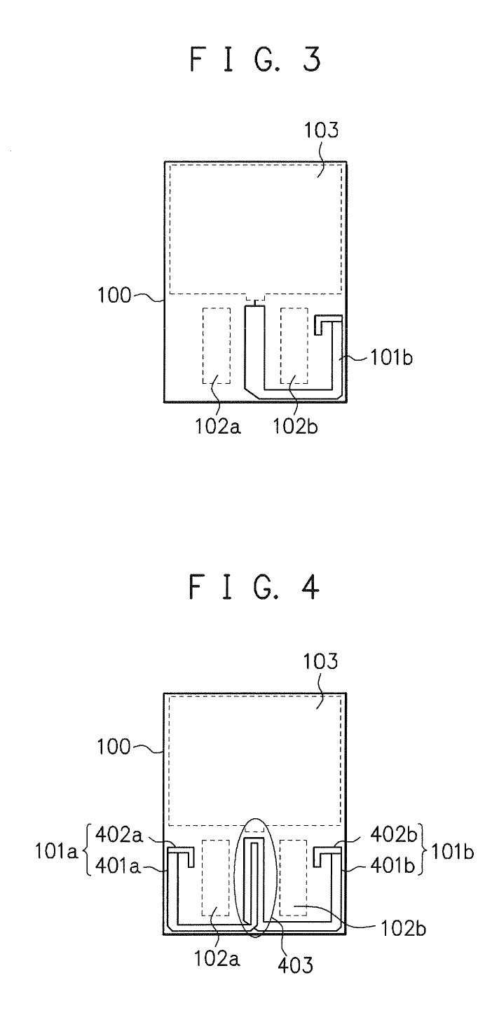

FIG. 1 to FIG. 3 are views illustrating a configuration example of a dipole antenna according to an embodiment and view seen from the similar direction. FIG. 2 is a view illustrating a front surface of a substrate 100, FIG. 3 is a view illustrating a rear surface of the substrate 100, and FIG. 1 is a view illustrating the front surface and the rear surface of the substrate 100 seen through the substrate 100.

The antenna of this embodiment is used for small-sized radio devices such as cellular phone, cordless phone, wireless radio communication PC (personal computer) card, USB data communication radio device, RF-ID and the like.

The substrate 100 is a substrate made of a dielectric material, for example, a glass epoxy substrate (FR4). The substrate 100 is preferably a substrate made of high-dielectric material. The substrate 100 has two through holes 102a and 102b. The via 102a and 102b each have a shape of a long hole.

Referring to FIG. 2, a front surface pattern of the substrate 100 will be described. On the front surface of the substrate 100, a first antenna element 101a made of a copper foil and a ground region 103 are provided. The first antenna element 101a has a U-shaped form.

Next, referring to FIG. 3, a rear surface pattern of the substrate 100 will be described. On the rear surface of the substrate 100, a second antenna element 101b made of a copper foil and a ground region 103 are provided. The second antenna element 101b has a U-shaped form.

The ground regions 103 on the front surface and the rear surface of the substrate 100 are mutually coupled via through holes in the ground regions 103. A through hole 102a is provided within the U-shape of the first antenna element 101a, and a though hole 102b is provided within the U-shape of the second antenna element 101b.

An end portion of the first antenna element 101a is coupled to a communication circuit 202 or 203 via a switch 201. The communication circuit 202 is a receiving circuit, and the communication circuit 203 is a transmission circuit. The first antenna element 101a is a feed antenna element to which power is fed from the transmission circuit 203. On the rear surface of the substrate 100, an end portion of the second antenna element 101b is coupled to the ground region 103. The second antenna element 101b is a parasitic antenna element.

FIG. 4 corresponds to FIG. 1 and is a view for explaining details of the antenna elements 101a and 101b. The first antenna element 101a has a radio wave radiating antenna region 401a and an impedance matching antenna region 402a. The second antenna element 101b has a radio wave radiating antenna region 401b and an impedance matching antenna region 402b. The radio wave radiating antenna regions 401a and 401b are regions contributing to radio wave radiation. The impedance matching antenna regions 402a and 402b are regions contributing to impedance matching. An output end of the transmission circuit 203 is matched at 50Ω. At the experimental stage the antenna, the lengths of the impedance matching antenna regions 402a and 402b are adjusted to bring the impedances of the antenna elements 101a and 101b to 50Ω for matching. By the impedance matching, the antenna elements 101a and 101b may prevent reflection of the transmitted wave from the transmission circuit 203.

The first antenna element 101a and the second antenna element 101b have regions projected via the substrate 100 including regions 403 mutually overlapping and other regions not mutually overlapping. The regions 403 are region which do not function as the antenna. By adjusting boundary positions between the regions 403 and the other regions, the frequency band in which the first antenna element 101a and the second antenna element 101b operate as the antenna may be adjusted.

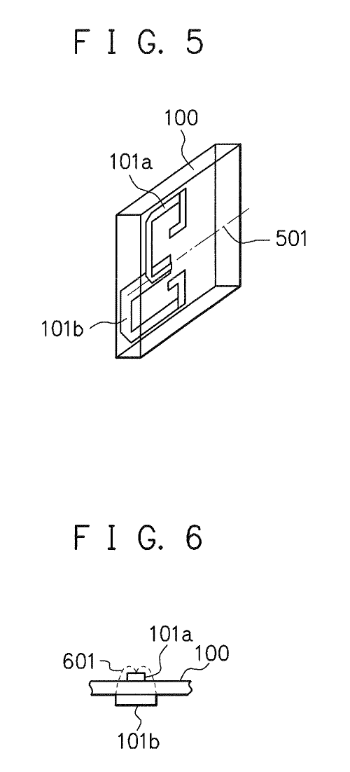

FIG. 5 is a perspective view illustrating the first antenna element 101a on the front surface of the substrate 100 and the second antenna element 101b on the rear surface. The first antenna element 101a and the second antenna element 101b have regions projected via the substrate 100 about a line 501 including regions 403 mutually overlapping.

FIG. 6 is a sectional view of the region 403 where the first antenna element 101a and the second antenna element 101b mutually overlap. The first antenna element 101a is provided on the front surface of the substrate 100, and the second antenna element 101b is provided on the rear surface of the substrate 100. The first antenna element 101a and the second antenna element 101b have a microstip line structure in which they are provided to hold the substrate 100 there between. This may make it possible to shorten the antenna elements 101a and 101b to reduce the size of the antenna. Note that the lengths of the antenna elements 101a and 101b depend on the wavelength of the resonant frequency. The first antenna element 101a is narrower in width in the mutually overlapping region 403 than the second antenna element 101b. This may make it possible to prevent radiation of a radio wave 601.

The first antenna element 101a in the mutually overlapping region 403 is provided with a coupling point to the communication circuit 202 or 203 in FIG. 2. For example, the first antenna element 101a is provided with, at one end portion thereof, the coupling point to the communication circuit 202 or 203 and has, at the other end portion thereof, the impedance matching antenna region 402a as a turned-back pattern for impedance matching.

Similarly, the second antenna element 101b is provided with, at one end portion thereof, a coupling point to the ground region 103 in FIG. 3 and has, at the other end portion thereof, the impedance matching antenna region 402b as a turned-back pattern for impedance matching.

The impedance matching antenna regions 402a and 402b are provided at end portions in the above-described not-mutually-overlapping regions.

According to this embodiment, the antenna elements 101a and 101b are arranged on the front surface and the rear surface of the dielectric material substrate 100, so that the electric length of a signal is shortened due to the dielectric constant of the dielectric material substrate 100. Thus, the antenna elements 101a and 101b may be shortened to downsize the antenna. Further, by bending the antenna elements 101a and 101b into a U-shaped form, the resonant frequency band of the antenna itself may be widened.

Further, the antenna elements 101a and 101b are bent inward at their open end sides to provide the impedance matching antenna regions 402a and 402b. The impedance matching antenna regions 402a and 402b will be regions contributing to impedance matching. The antenna elements 101a and 101b may be separated into the regions 402a and 402b contributing to the impedance matching and the regions 401a and 401b contributing to the radio wave radiation.

Further, the via 102a and 102b in the long-hole shape are provided adjacent to the antenna elements 101a and 101b, thereby causing discontinuity of the dielectric constant. The dielectric constant ∈r of the glass epoxy substrate 101 is 4.8, whereas the dielectric constant ∈r of air existing in the via 102a and 102b is 1. Due to the discontinuity of the dielectric constant, the antenna elements 101a and 101b may exist as elemental units independent in terms of high frequency to widen the bandwidth of the resonant frequency of the antenna. This may make the antenna insusceptible to the influence of the casing of a radio device in which the antenna is installed, the influence of a conductor placed near the antenna, or the influence of radio wave radiation characteristics caused by the influence when a human body touches the antenna.

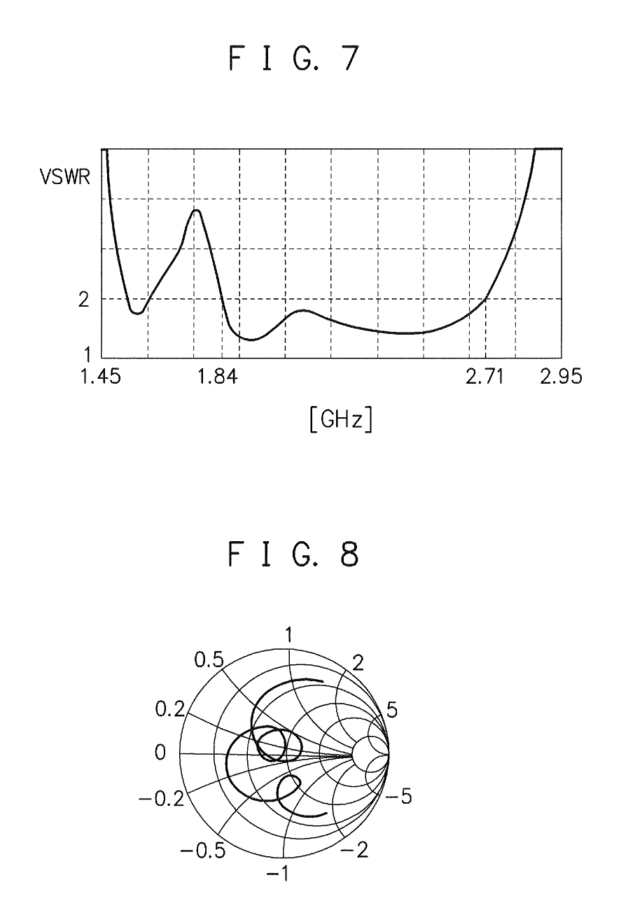

FIG. 7 and FIG. 8 are views depicting measurement results of the resonant frequency bandwidth of the antenna according to this embodiment. FIG. 7 is a graph depicting the relation between the frequency and the voltage standing wave ratio (VSWR), and FIG. 8 is a Smith chart.

In the measurement test, the voltage standing wave ratio in FIG. 7 and the impedance in FIG. 8 were measured while varying the frequency from 1.45 [GHz] to 2.95 [GHz]. When the voltage standing wave ratio is 1, the impedance matching is attained, so that the antenna impedance becomes 50Ω. The center (middle) of the Smith chart in FIG. 8 indicates 50Ω. A voltage standing wave ratio of 2 or less means wide antenna characteristics. The frequency bandwidth of a voltage standing wave ratio of 2 or less is 1.84 to 2.71 [GHz]. The usable frequency bandwidth is referred to as discontinuitywidth. The discontinuitywidth is expressed by the following expression.

f=(2.71−1.84)/{1.84+(2.71−1.84)/2}×100≈38%

Note that, as a result of a similar measurement performed on a first comparative example of the antenna having no through holes 102a and 102b and antenna elements 101a and 101b in a linear shape in FIG. 1, the discontinuitywidth was 25%.

Further, as a result of a similar measurement performed on a second comparative example of the antenna having no through holes 102a and 102b and antenna elements 101a and 101b in a U-shaped form in FIG. 1, the discontinuitywidth was 30%. By making the antenna elements 101a and 101b into the U-shaped form, the discontinuitywidth may be widened as compared to the first comparative example.

Further, as a result of measurement performed on the antenna having the via 102a and 102b and the antenna elements 101a and 101b in a U-shaped form as in the above-described present embodiment, the discontinuitywidth was 38%. By providing the via 102a and 102b, the discontinuitywidth may be further widened as compared to the second comparative example. In the present embodiment, the discontinuitywidth may be widened by 13% or more as compared to the first comparative example.

Note that the via 102a and 102b are for causing the discontinuity of the dielectric constant of the substrate 100, so that a material having a dielectric constant different from that of the substrate 100 may be provided in the via 102a and 102b.

For example, the regions 102a and 102b may be different dielectric constant regions having a dielectric constant different from that of the dielectric constant of the substrate 100 provided within the substrate 100. The different dielectric constant regions 102a and 102b may be through holes in the substrate 100 as in the above-described embodiment. Further, the different dielectric constant regions 102a and 102b may be the regions through the substrate 100 in which are a material having the above-described different dielectric constant is provided. The above-described material having a different dielectric constant is, for example, polytetrafluoroethylene (the dielectric constant ∈r=18.6 to 68.4), ABS (acrylonitrile butadiene styrene) resin (the dielectric constant ∈r≈3.0), or vinyl (the dielectric constant ∈r≈2.0) or the like.

Though the case where the different dielectric constant regions 102a and 102b are in the U-shaped form has been explained, they are not limited to such a shape but may be in an L-shaped form or the like. The first different dielectric constant region 102a is provided adjacent to the first antenna element 101a, and the second different dielectric constant region 102b is provided adjacent to the second antenna element 101b.

According to this embodiment, by providing the different dielectric constant regions 102a and 102b and/or making the antenna elements 101a and 101b in the U-shaped form, the resonant frequency band may be widened to reduce the change in the radio wave radiation characteristics due to external influence.

Note that the present embodiment is to be considered in all respects as illustrative and no restrictive, and all changes which come within the meaning and range of equivalency of the claims are therefore intended to be embraced therein. The invention may be embodied in other specific forms without departing from the spirit or essential characteristics thereof.

The resonant frequency band is widened to reduce the change in the radio wave radiation characteristics due to external influence.

What is claimed is:

1. An antenna, comprising:
a substrate made of a dielectric material;
a first different dielectric constant region having a dielectric constant different from a dielectric constant of said substrate provided in said substrate; and
a first antenna element provided on a front surface of said substrate.

2. The antenna according to claim 1, wherein said first different dielectric constant region is a through hole in said substrate.

3. The antenna according to claim 1, wherein said first different dielectric constant region is a region through said substrate in which a material having the different dielectric constant is provided.

4. The antenna according to claim 1, wherein said first different dielectric constant region is provided adjacent to said first antenna element.

5. The antenna according to claim 1, wherein said first antenna element is in a U-shaped form.

6. The antenna according to claim 5, wherein said first antenna element has at an end portion thereof a turned-back pattern for impedance matching.

7. The antenna according to claim 1, further comprising:
a second antenna element provided on a rear surface of said substrate.

8. The antenna according to claim 7, wherein said first and second antenna elements have regions projected via said substrate including regions mutually overlapping and regions not mutually overlapping.

9. The antenna according to claim 8, wherein said first antenna element is narrower in width in said mutually overlapping region than said second antenna element.

10. The antenna according to claim 7, wherein said first antenna element is coupled to a communication circuit, and said second antenna element is coupled to ground.

11. The antenna according to claim 10, further comprising:
ground regions provided on the front surface and the rear surface of said substrate,
wherein said second antenna element is coupled to said ground region.

12. The antenna according to claim 10,
wherein said first and second antenna elements have regions projected via said substrate including regions mutually overlapping and regions not mutually overlapping, and
wherein said first antenna element in said mutually overlapping region is provided with a coupling point to said communication circuit.

13. The antenna according to claim 12, wherein said first antenna element is provided with, at one end portion thereof, the coupling point to said communication circuit.

14. The antenna according to claim 13, wherein said first antenna element has, at another end portion thereof, a turned-back pattern for impedance matching.

15. The antenna according to claim 14, wherein said second antenna element has, at an end portion thereof, a turned-back pattern for impedance matching.

16. The antenna according to claim 5, wherein said first different dielectric constant region is provided in the U-shaped form of said first antenna element.

17. The antenna according to claim 7, further comprising:
a second different dielectric constant region having a dielectric constant different from a dielectric constant of said substrate provided in said substrate,
wherein said first different dielectric constant region is provided adjacent to said first antenna element, and said second different dielectric constant region is provided adjacent to said second antenna element.

18. An antenna, comprising:
a substrate made of a dielectric material; and
a first antenna element in a U-shaped form provided on a front surface of said substrate.

19. The antenna according to claim 18, further comprising:
a second antenna element in a U-shaped form provided on a rear surface of said substrate.

20. The antenna according to claim 19, wherein said first and second antenna elements have regions projected via said substrate including regions mutually overlapping and regions not mutually overlapping.
